(19) United States
(12) Patent Application Publication
(10) Pub. No.: US 2013/0265741 A1
(43) Pub. Date: Oct. 10, 2013

(54) MULTI-HUES LIGHT EMITTING DIODE ILLUMINATED KEYBOAD

(71) Applicant: Hyung Tae Lee, Seoul (KR)

(72) Inventor: Hyung Tae Lee, Seoul (KR)

(21) Appl. No.: 13/726,698

(22) Filed: Dec. 26, 2012

(30) Foreign Application Priority Data
Apr. 6, 2012 (KR) 10-2012-0035952

(51) Int. Cl. H01H 13/83

(52) U.S. Cl. CPC H01H 13/83
USPC 362/23.03

(57) ABSTRACT

The present invention provides a multi-hues LED illuminated keyboard, which controls LED components with specific color hues to illuminate by pressing a specific key. The multi-hues LED illuminated keyboard according to the present invention merely uses a micro control unit (MCU) commonly used in a keyboard of a computer, and connects switch circuits capable of controlling the LED components with the specific color hues to an output terminal of a GPIO of the MCU, to make a plurality of keys of the keyboard illuminate with multiple color hues. Therefore, the multi-hues LED illuminated keyboard according to the present invention brings in advantages of low cost and easy use.

### FIELD OF THE INVENTION

The present invention relates to a light emitting diode (LED) illuminated keyboard, and more particular, LED components are installed in multiple keys of a computer-used keyboard, and color hues of the multiple keys are different according to an operation condition of the computer. In other words, based on operation condition of software programs, the multiple keys are changed to related key modes automatically, and are categorized into a plurality of groups to illuminate with designated color hues respectively. Therefore, an operation convenience of the keyboard is improved, namely, the multi-hues LED illuminated keyboard is convenient for use.

### DESCRIPTION OF RELATED ART

When a computer is used in a dark environment, keys of a keyboard cannot be identified accurately and thus an additional illuminating device is needed, or the keys need to be identified with assistance of light illuminated from a display device. This brings inconvenience for using the keyboard. Accordingly, techniques of installing backlight elements in the keys of the keyboard are proposed. The techniques can be references to following patent documents.

Patent documents: Korean patent publications No. 2000-0002926, No. 2004-0100115, No. 2005-002275, No. 2007-0006188, No. 2007-0054299, No. 2008-0112616, No. 2010-0043126, and No. 2011-0049058; Korean issued patent No. 0865896 and No. 0830522; Korean utility model publications No. 1998-018311, No. 2011-0006385, and No. 2011-0000722, etc.

However, in the above technique, LED components are simply used as the backlight of the keys, thus the multiple keys of the keyboard can only illuminate with a single color hue.

Accordingly, it is proposed that each key is configured with red (R), green (G), blue (B) three LED components respectively (red, green, blue are three-primary colors of light), and the keys of the keyboards are controlled to illuminate with different color hues by use of a control electrical signal. However, in the existing techniques, to realize the above-mentioned effect, in addition to a commonly used micro control unit (MCU), another micro control unit (MCU) which is capable of controlling light illumination needs to be additionally configured in the keyboard; or, an micro control unit which includes an additional function of light illumination control needs to be re-designed to replace the commonly used micro control unit. In case that the first technique is employed, the additional micro control unit (MCU) which is capable of controlling light illumination brings in an increase of cost, and moreover, great effort should be made for integration of the entire system, this causes the cost to be further increased, and may also raise instability to the system. In case that the second techniques is employed, because it is required to re-design the micro control unit including an additional function of light illumination control on the basis of a normal function of the micro control unit, the cost also needs to be increased.

Besides, in order to solve the above-mentioned problem, proposal has been raised on controlling color due of light emitted by each of the keys of the keyboard by implementing computer program, however, it cannot be achieved by use of an existing micro control unit that is commonly used in the keyboard, and consequently, the micro control unit still needs to adopt the above two structures. Patent documents mentioning the above contents including: Korean patent publications No. 2003-0079885 and No. 2009-0124630; Korean issued patent No. 0527264, No. 1007855 and No. 0998996, etc.

### BRIEF DESCRIPTION OF THE DRAWINGS

FIG. 1 is a schematic apparent diagram of an LED illuminated keyboard which illuminates with different color hues in accordance with different functions according to a preferred embodiment of the present invention.

FIG. 2 is another schematic apparent diagram of an LED illuminated keyboard which illuminates with different color hues in accordance with functions according to a preferred embodiment of the present invention.

FIG. 3 is a functional diagram of a micro control unit (MCU) of the LED illuminated keyboard which illuminates with different color hues in accordance with different functions of FIG. 1.

FIG. 4 is a schematic diagram of a first switch circuit which controls illumination of LED components in accordance with a output signals of GPIO of the micro control unit (MCU).

FIG. 5 is a schematic diagram of a second switch circuit which controls the illumination of LED components in accordance with output signals of GPIO of the micro control unit (MCU).

FIG. 6 is a schematic diagram of a third switch circuit which controls the illumination of LED components in accordance with output signals of GPIO of the micro control unit (MCU).

### SUMMARY

In view of the above problem, the present invention provides a multi-hues LED illuminated keyboard in which multiple keys of the keyboard illuminates with multiple color hues by just use of a micro control unit (MCU) commonly used in a computer keyboard.

An multi-hues LED illuminated keyboard, includes a plurality of keys and a micro control unit (MCU) for transmitting signals generated by the keys to a computer, LED components are respectively disposed beneath the plurality of keys to provide light for corresponding keys; wherein the keys include a control signal generating key, the control signal generating key is configured to generate a control signal; the LED components include a plurality of LED components with a first color hue, the LED components with the first color hue is categorized into a first group and a second group; the LED components further includes LED components with a second color hue or LED components with at least one color hue selected from a third color hue, a fourth color hue and a fifth color hue that are disposed in the keys in which the first group of the LED components with the first color hue are disposed; the LED illuminated keyboard further includes switch circuits for controlling illumination of the LED components according to output signals of a GPIO of the micro control unit (MCU), the switch circuits include a first switch circuit for controlling, when the control signal generating key is in an ON state, the LED components with the second color hue to illuminate, or controlling the LED components with the at least one color hue selected from the third color hue, the fourth color hue and the fifth color hue to illuminate, and a second switch circuit for controlling, when the control signal generating key is in an OFF state, the first group of the LED components with the first color hue to illuminate;

As a further improvement of the multi-hues LED illuminated keyboard, the micro control unit (MCU) is configured to enable the second group of the LED components with the first color hue to illuminate when the keys are pressed to transmit original values thereof to the computer.

As a further improvement of the multi-hues LED illuminated keyboard, the micro control unit (MCU) is constituted by a single IC chip.

As a further improvement of the multi-hues LED illuminated keyboard, the control signal generating key is a Caps Lock key, and the keys in which the LED components with the second color hue are disposed are the Caps Lock key and 26 alphabet keys.

As a further improvement of the multi-hues LED illuminated keyboard, the control signal generating key is a Fn key newly added in a normal keyboard, and the keys in which the LED components with the at least one color hue selected from the third color hue, the fourth color hue and the fifth color hue are disposed are the Fn key and function extending keys, the function extending keys are keys making the computer implement functions different from original functions of the keys being pressed when the Fn key is in an ON state.

As a further improvement of the multi-hues LED illuminated keyboard, the function extending keys are selected from multi-media function keys, shortcut keys and function enhancing keys; the multi-media function keys are configured for executing functions of a multi-media program when the computer implements the multi-media program; the shortcut keys are configured for executing a specific procedure in a certain program when the computer implements the program and the function extending keys are pressed, and the function enhancing keys having other key values when the function key (Fn key) is in the ON state, even if the function enhancing keys have unique values when being combined with a Shift key, a Ctrl key or an Alt key.

As a further improvement of the multi-hues LED illuminated keyboard, the LED illuminated keyboard is a Qwerty type wireless mini-keyboard, a power supply is provided to the LED components when the keyboard is connected to the computer, the provision of the power supply enables the LED components with the first color hue to implement an illumination initialization process.

Compared with the exiting techniques, the multi-hues LED illuminated keyboard according to the present invention dose not need to configure with an additional MCU, and only a commonly used MCU in the keyboard is used to realize illumination of various kinds of light, therefore, the keyboard according to the present invention has a low cost and a simple configuration.

### DETAILED DESCRIPTION

Reference will now be made to the drawings to describe the multi-hues LED illuminated keyboard according to the present invention in detail.

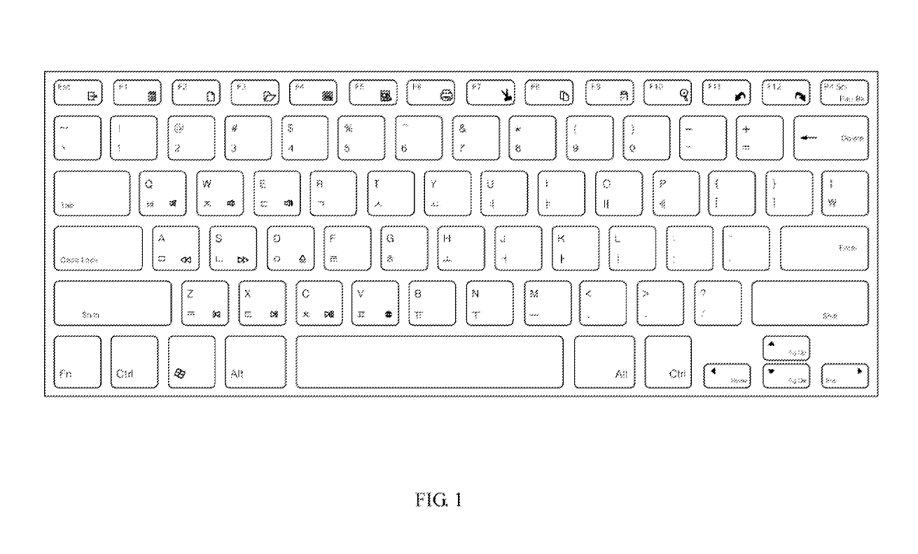

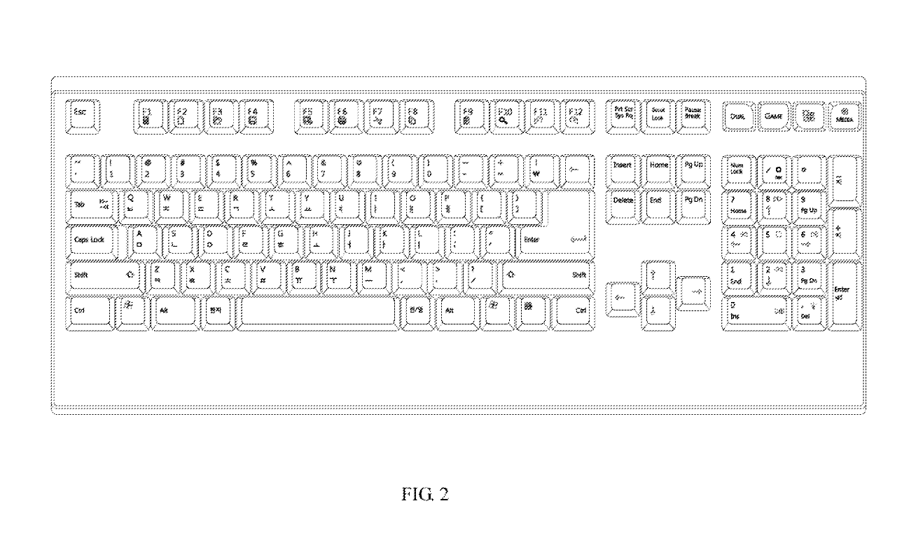

FIG. 1 and FIG. 2 are two kinds of schematic apparent diagram of the multi-hues LED illuminated keyboard according to a preferred embodiment of the present invention. The multi-hues LED illuminated keyboard according to the present invention includes a plurality of keys. The keyboard as illustrated in FIG. 1 is a Qwerty type wireless mini-keyboard, however, the multi-hues LED illuminated keyboard according to the present invention is not limited to this type of keyboard, any computer used keyboard is applicable, as well as a notebook keyboard or a wired mini-keyboard. The Qwerty type wireless mini-keyboard is convenient for movement and is commonly used recently, and has a key arrangement as illustrated in FIG. 1, which includes 78˜82 keys in total. Although only 78 keys are illustrated in FIG. 1, the number of keys can be increased as required. For example, a Korean/English switch key for switching Korean and English and a Korean/Chinese switch key for switching Korean and Chinese can be added, in this case, the total number of keys are 80. Moreover, a location of a function key (Fn key) as illustrated in FIG. 1 can be alternatively designed for easy use. The keyboard as illustrated in FIG. 2 is a standard size keyboard with similar color hue group in corresponding to the different operation mode like the mini-keyboard as illustrated in FIG. 1, and the Fn is other function extending keys.

LED components are respectively disposed beneath the multiple keys for providing light to corresponding keys. The LED components includes LED components with a first color hue, the LED components with the first color hue may be respectively disposed in all or part of the keys. Preferably, the LED components with the first color hue may be respectively disposed in all of the keys. The LED components with the first color hue are categorized, namely, into a first group and a second group. The so-called categorization means that the LED components with the first color hue are turned on turned off on a group basis. The LED components may further include LED components with a second color hue, the LED components with the second color hue are respectively disposed in the keys in which the first group of the LED components with the first color hue has already disposed. LED components with other color hues may also be disposed in the keys in which the first group of the LED components with the first color hue are disposed, the other color hues may be at least one of color hues selected from a third color hue, a fourth hue and a fifth color hue. The disposing and wiring of the LED components in each of the keys is known as existing techniques. Description of driving of the LED components applicable to the present invention is provided as follows.

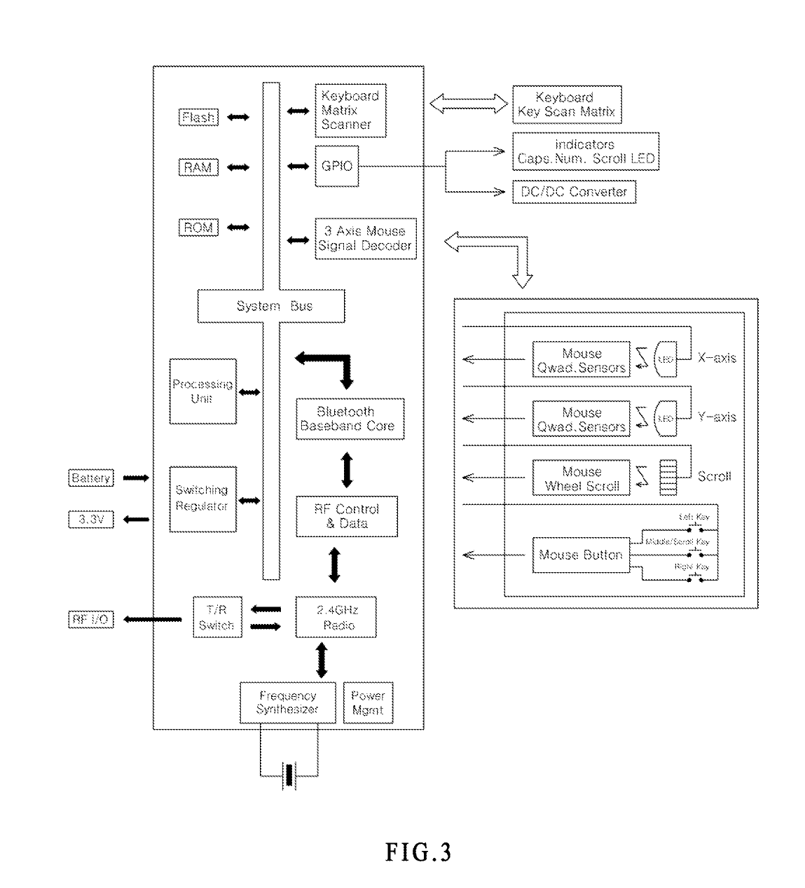

The keyboard according to the present invention includes a micro control unit (MCU) for transmitting signals generated in responsive to pressing of the keys to a computer. The MCU is an MCU commonly used in an existing computer-used keyboard. In a preferred embodiment of the keyboard according to the present invention, no other MCU is disposed in the keyboard except for the MCU constituted by a single IC chip. FIG. 3 is a functional diagram of an MCU applicable to a normal keyboard. In the MCU as illustrated in FIG. 3, it should be particularly noted that a GPIO (general purpose input/output) for extending functions of the MCU is provided. The GPIO is used for controlling LED components with specific color dues to illuminate by pressing a specific key. Therefore, the present invention can enable the keys in the keyboard to illuminate with different color dues in group by a low cost and a simple solution. In a normal keyboard, the GPIO is generally used for control of indicator lamps. The indicator lamps are normally lamps for indicating an ON or OFF state of a Cap Lock key, a Num Lock key, a Scroll Lock key, etc.

The LED illuminated keyboard includes a control signal generating key, the control signal generating key generates a control signal for controlling illumination of the LED components. Preferably, the control signal generating key is the Caps Lock key or the Fn key. Although the Fn key cannot be found in a normal computer used keyboard, it is frequently used in an existing mini-keyboard.

The keys in which the LED components with the second color hue are disposed are the Caps Lock key and 26 alphabet keys; the keys in which the LED components with the at least one color hue selected from the third color hue, the fourth hue and the fifth color hue are disposed are the Fn key and function extending keys. The so-called function extending keys are the keys making the computer implement functions different from original functions of the keys when being pressed upon the condition that the Fn key is in an ON state, for example, multi-media function keys for executing functions of a multi-media program when the computer implements the multi-media program, shortcut keys capable of executing a specific procedure in a certain program when the computer implements the program and the function extending keys are pressed, and function enhancing keys having other key values when the function key (Fn key) is in the ON state, even if the function enhancing keys have unique values when being combined with a Shift key, a Ctrl key or an Alt key.

As illustrated in FIG. 1, the multi-media function keys are configured at the alphabet keys Q, W, E, A, S, D, Z, X, C, V, etc. In this case, when the multi-media program is implemented, play/stop function of the selected music, video, or the like is executed upon the condition that the alphabet key C is pressed while the Fn key is in the ON state. During the music or video is played, mute function is executed upon the condition that the alphabet key Q is pressed while the Fn key is in the ON state. In the keyboard as illustrated in FIG. 1, these multi-media functions are identified by use of symbols on the corresponding keys. The symbols are regular symbols. The LED components with the third color hue are disposed in the multi-media function keys.

As illustrated in FIG. 1, the shortcut keys are configured at the Esc key, the F1˜F12 keys and the PrtScr key. The Esc key has an exiting (Exit) function; the F1 key has a computing function; the F2 key has a newly setting up (New) function; the F3 key has a document opening (Open) function; the F4 key has a saving (Save) function; the F5 key has a saving-as (Save As) function; the F6 key has a printing (Print) function; the F7 key has a cutting (Cut) function; the F8 key has a copying (Copy) function; the F9 key has a pasting (Paste) function; the F10 key has a finding (Find) function; the F11 key has a undoing (Undo) function; the F12 key has a redoing (Redo) function; the PrtScr key has a pausing and breaking (Pause Break, Pau_Bk) function. The LED components with the fourth color hue are disposed in the shortcut keys.

As illustrated in FIG. 1, besides of the function extending keys defined above, other function extending keys are configured in the keyboard according to the present invention, such as four direction keys and a Backspace key. The left direction key further has function of a Home key; the right direction key further has function of a End key; the upward direction key further has function of a Pageup key; the downward direction key further has function of a Pagedown key; and the Backspace key further has function of a Delete key. When a program such as Word is implemented, the function of the Home key is executed upon the condition that the left direction key is pressed while the Fn key is in the ON state. Since the wireless mini-keyboard is a small-sized keyboard, it is impossible to dispose all the keys thereon, consequently, the configuration of these function extending keys are necessary. Therefore, the function of the Home key, the function of the End key, the function of the Pageup key, the function of the Pagedown key and the function of the Delete key are respectively configured in the four direction keys and the Backspace key, as described above. The LED components with the fifth color hue are disposed in the function extending keys.

Although the above configuration of keys can be seen in the normally used mini-keyboard, the normally used mini-keyboard does not include the LED components illumination control as provided in the present invention.

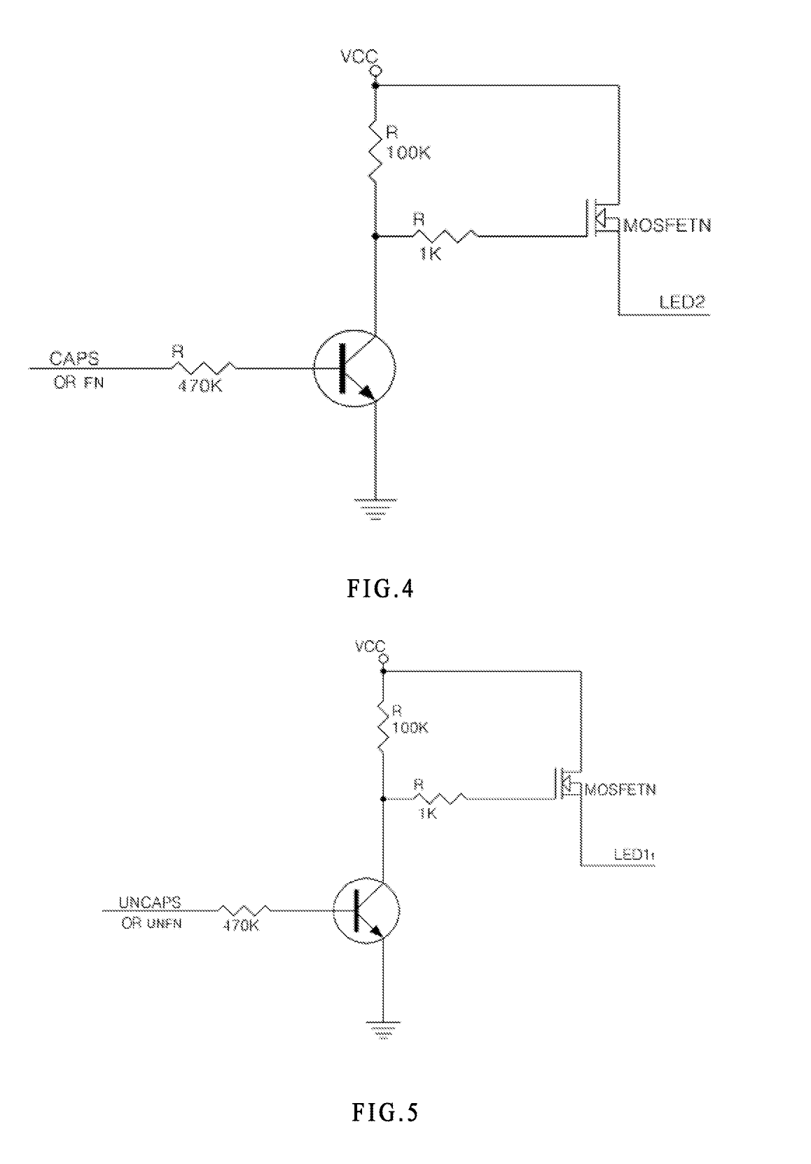

The keyboard according to the present invention includes switch circuits for controlling illumination of the LED components according to output signals of the GPIO of the MCU. The switch circuits are connected to an output terminal of the GPIO. The switch circuits include a first switch circuit for enabling the LED components with the second color hue to illuminate when the control signal generating key (Caps Lock key) is in the ON state, or enabling the LED components with at least one color hue selected from the third color hue, the fourth color hue and the fifth color hue to illuminate when the control signal generating key (Fn key) is in an ON state, and a second switch circuit for enabling the first group of the LED components with the first color hue to illuminate when the control signal generating key (Caps Lock key or Fn key) is in an OFF state. Embodiments of these switch circuits can be referred to FIG. 4-6.

Moreover, upon the condition that the keys of the keyboard are pressed to transmit original values thereof to the computer, the MCU controls the second group of the LED components with the first color hue to illuminate. The control can be implemented by providing power supply to all of the LED components or cut-off the power supply.

Details of how to control the LED components with various color hues to illuminate are described below with reference to FIGS. 4-6.

Firstly, if the keyboard according to the present invention is wireless mini-keyboard, the wireless mini-keyboard is connected to the computer host through Bluetooth communication to enter an input ready state when the computer is in an ON state. At this moment, the keyboard provides power supply to the LED components, and accordingly the LED components with the first color hue illuminate. By means of such initialization state, all of the LED components with the first color hue are set to illuminate. Once the power supply is provided, the second group of the LED components with the first color hue illuminate, the illumination of the second group of the LED components with the first color hue is controlled by a program stored in a ROM of the MCU. Details of illumination of the first group of the LED components with the first color hue are described below.

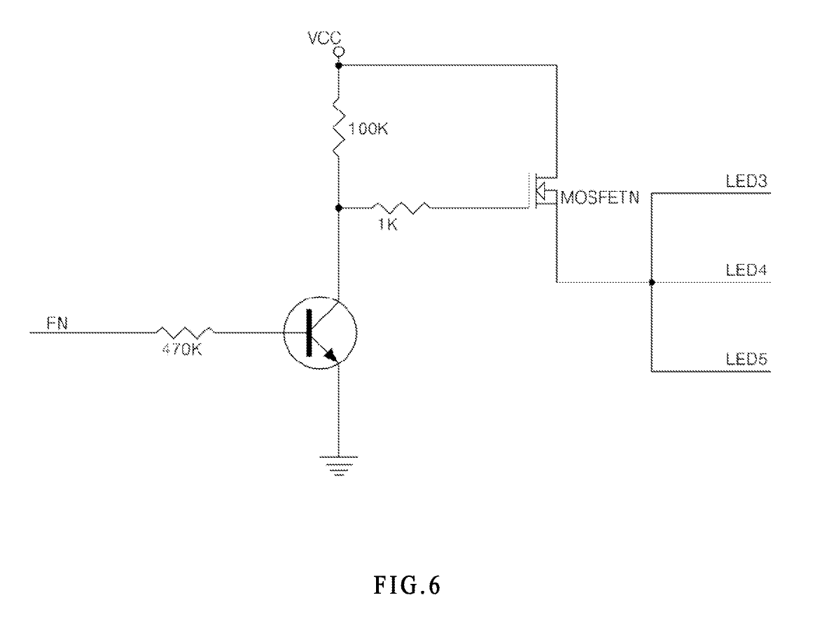

In the initialization state, the control signal generating key (Caps Lock key or Fn key) is in an OFF state, therefore, it can be known from the circuit as illustrated in FIG. 5 that the first group of the LED components with the first color hue illuminate. Referring to the switch circuit as illustrated in FIG. 5, when the Caps Lock key or Fn key is in the OFF state, a LOW control signal serving as an UNCAPS signal or an UNFN signal is input to a transistor, therefore, all the first group of the LED components with the first color hue connecting to the circuit illuminate. In FIG. 5, LED1₁ represents the first group of the LED components with the first color hue. Referring also to the switch circuits as illustrated in FIG. 4 and FIG. 6, because the Caps Lock key or Fn key is in the OFF state, no CAPS signal or FN signal is generated to input a HIGH control signal to the transistor, therefore, all the LED components with the second hue, or the LED components with the third color hue, the fourth color hue and the fifth color hue, which are connected to the switch circuits, do not illuminate. In FIG. 4, LED2 represents the LED components with the second color hue; in FIG. 6, LED3 represents the LED components with the third color hue, LED4 represents the LED components with the fourth color hue, LEDS represents the LED components with the fifth color hue.

Therefore, when the keyboard according to the present invention is in the initialization state, through controlling the first group of the LED components with the first color hue to illuminate by the switch circuit as illustrated in FIG. 5, and controlling the second group of the LED components with the first color hue to illuminate by the micro control unit (MCU), all the LED components with the first color hue are enabled to illuminate.

Secondly, as a first embodiment, when it is desired to successively input capital letters, the Caps Lock key is pressed once to make the Caps Lock key in the ON state, in this circumstance, capital letters can be input by pressing the alphabet keys. To identify this type of input state better and to make the input more convenient, the Caps Lock key and the 26 alphabet keys of the keyboard according to the present invention are illuminated with the second color hue. In this case, the Caps Lock key and the 26 alphabet keys of the keyboard according to the present invention are not illuminated with the first color hue, while other keys are illuminated with the first color hue, details are as follows.

When the user press Caps Lock key to make it in the ON state, a CAPS signal (i.e., a LOW control signal) is input to the transistor of the switch circuit in FIG. 4, and thus all the LED components with the second color hue illuminate. At the same time, as the Caps Lock key is in the ON state, no UNCAPS signal is input to the switch circuit in FIG. 5, thus the first group of the LED components with the first color hue are in a non-illumination state. Moreover, the power supply provided to the second group of the LED components with the first color hue is maintained, thus the second group of the LED components with the first color hue maintain an illumination state. In this circumstance, the second group of the LED components with the first color hue and the LED components with the second color hue are in the illumination state, while other LED components are in the non-illumination state. Accordingly, because both the Caps Lock key and the 26 alphabet keys illuminate with the second color hue, the Caps Lock key and the 26 alphabet keys can be identified better, and thus the input operation of the Caps Lock key and the 26 alphabet keys is more convenient. Moreover, other keys than the Caps Lock key and the 26 alphabet keys still illuminate with the first color hue, thus the keys can be identified and operated easily in a dark circumstance.

When the Fn key is configured as the control signal generating key (second embodiment), the above process can also be applied. The function extending keys used when the Fn key is in the ON state can be categorized into three types, and illuminate with different color hues, to facilitate the use of the function extending keys. The followings describes the second embodiment with reference to FIG. 6.

The function extending keys used when the Fn key is in the ON state are multi-media function keys, shortcut keys and other function extending keys (for example, the four direction key and the Backspace key). It is assumed that the LED components with the third color hue are disposed in the multi-media function keys, the LED components with the fourth color hue are disposed in the shortcut keys, and the LED components with the fifth color hue are disposed in other function extending keys.

When the Fn key is pressed to make the Fn key is in the ON state, an Fn signal is input to the switch circuit in FIG. 4 or FIG. 6, thus all the LED components with the second color hue are in the illumination state, or all the LED components with the third color hue, the fourth color hue and the fifth color hue are in the illumination state. No UNFN signal is input to the switch circuit in FIG. 5, thus the first group of the LED components with the first color hue are in the non-illumination state. Moreover, the power supply (Vcc) provided to the second group of the LED components with the first color hue is maintained, thus the second group of the LED components with the first color hue maintain the illumination state. Therefore, when the Fn key is in the ON state, the second group of the LED component with the first color hue and the LED components with the second color hue, or the third color hue, the fourth color hue and the fifth color hue are all in the illumination state, while other LED components are in the non-illumination state.

Besides, no matter which state the keyboard according to the present invention is in (for example, the Caps Lock key is in the ON or OFF state, or the Fn key is in the ON or OFF state), when no operation is performed on the keyboard within a time period defined by a program of the MCU, the power supply (Vcc) provided to all the LED components can be cut off by the MCU to make all the LED components stop illuminating to save power. When all the LED components do not illuminate, the keyboard according to the present invention is in a standby mode. In the standby mode, the keyboard can be immediately switched to an input ready mode when any one of the keys of the keyboard is pressed. Preferably, a value corresponding to the key being pressed (the value implementing the function of the key) is not transmitted to the computer when the keyboard is switched from the standby mode to the input ready mode, in this case, the key pressing merely functions as mode switching. When the keyboard re-enters the input ready mode after all the LED components are turned off for power saving in a certain state (i.e., switching from the standby mode to the input ready mode), the keyboard can recover to the previous illumination state.

As described above, the keyboard according to the present invention can automatically perform non-illumination and illumination switching on the LED components with different color hues simultaneously, therefore, the keyboard is convenient for use. Moreover, a commonly used MCU in keyboard can be used to realize the illumination of multiple kinds of light, without the need of an additional MCU, therefore, the keyboard according to the present invention has a low cost and a simple configuration.

It should be noted that the above embodiments are merely provided for describing the technical solutions of the present invention, but not intended to limit the present invention. To persons of ordinary skill in the art, various modifications and changes can be made to the present invention. Any modification, equivalent replacement, and improvement made by persons of ordinary skill in the art without departing from the spirit of the present invention shall fall within the protection scope.

What is claimed is:

1. A multi-hues LED illuminated keyboard, comprising a plurality of keys and a micro control unit (MCU) for transmitting signals generated by the keys to a computer, LED components are respectively disposed beneath the plurality of keys to provide light for corresponding keys;
wherein the keys comprise a control signal generating key, the control signal generating key is configured to generate a control signal;
the LED components comprise a plurality of LED components with a first color hue, the LED components with the first color hue is categorized into a first group and a second group; the LED components further comprises LED components with a second color hue or LED components with at least one color hue selected from a third color hue, a fourth color hue and a fifth color hue that are disposed in the keys in which the first group of the LED components with the first color hue are disposed;
the LED illuminated keyboard further comprises switch circuits for controlling illumination of the LED components according to output signals of a GPIO of the micro control unit (MCU), the switch circuits include a first switch circuit for controlling, when the control signal generating key is in an ON state, the LED components with the second color hue to illuminate, or controlling the LED components with the at least one color hue selected from the third color hue, the fourth color hue and the fifth color hue to illuminate, and a second switch circuit for controlling, when the control signal generating key is in an OFF state, the first group of the LED components with the first color hue to illuminate.

2. The multi-hues LED illuminated keyboard of claim 1, wherein the micro control unit (MCU) is configured to control the second group of the LED components with the first color hue to illuminate or not when the control signal generating key is pressed to transmit original values thereof to the computer.

3. The multi-hues LED illuminated keyboard of claim 1, wherein the micro control unit (MCU) is constituted by a single IC chip.

4. The multi-hues LED illuminated keyboard of claim 3, wherein the control signal generating key is a Caps Lock key, and the keys in which the LED components with the second color hue are disposed are the Caps Lock key and 26 alphabet keys.

5. The multi-hues LED illuminated keyboard of claim 3, wherein the control signal generating key is a Fn key newly added in a normal keyboard, and the keys in which the LED components with the at least one color hue selected from the third color hue, the fourth color hue and the fifth color hue are disposed are the Fn key and function extending keys, the function extending keys are keys making the computer implement functions different from original functions of the keys being pressed when the Fn key is in an ON state.

6. The multi-hues LED illuminated keyboard of claim 5, wherein the function extending keys are selected from multi-media function keys, shortcut keys and function enhancing keys;
wherein the multi-media function keys are configured for executing functions of a multi-media program when the computer implements the multi-media program; the shortcut keys are configured for executing a specific procedure in a certain program when the computer implements the program and the function extending keys are pressed, and the function enhancing keys having other key values when the function key (Fn key) is in the ON state, even if the function enhancing keys have unique values when being combined with a Shift key, a Ctrl key or an Alt key.

7. The multi-hues LED illuminated keyboard of claim 4, wherein the LED illuminated keyboard is a Qwerty type wireless mini-keyboard, a power supply is provided to the LED components when the keyboard is connected to the computer, the provision of the power supply enables the LED components with the first color hue to implement an illumination initialization process.

8. The multi-hues LED illuminated keyboard of claim 5, wherein the LED illuminated keyboard is a Qwerty type wireless mini-keyboard, a power supply is provided to the LED components when the keyboard is connected to the computer, the provision of the power supply enables the LED components with the first color hue to implement an illumination initialization process.
